(19) United States
(12) Patent Application Publication
(10) Pub. No.: US 2026/0050839 A1
(43) Pub. Date: Feb. 19, 2026

(54) METHODS AND APPARATUSES FOR THE SELECTION OF MACHINE LEARNING CLIENT MEMBERS AND MACHINE LEARNING SERVERS

(71) Applicant: Telefonaktiebolaget LM Ericsson (publ), Stockholm (SE)

(72) Inventors: Jing YUE, Danderyd (SE); Zhang FU, Stockholm (SE)

(73) Assignee: Telefonaktiebolaget LM Ericsson (publ), Stockholm (SE)

(21) Appl. No.: 19/102,031

(22) PCT Filed: Aug. 8, 2023
(86) PCT No.: PCT/EP2023/071927

§ 371 Date: Feb. 7, 2025

Related U.S. Application Data
(60) Provisional application No. 63/370,846, filed on Aug. 9, 2022.

(51) Int. Cl. G06N 20/20

(52) U.S. Cl. CPC G06N 20/20

(57) ABSTRACT

Embodiments described herein relate to methods and apparatuses for selection of one or more ML client members from a plurality of potential ML client members to perform federated learning. A method in an application function comprises responsive to commencement of the federated learning, obtaining first analytics information relating to communication performance between potential groups of ML servers and a plurality of potential ML client members; and selecting, based on the first analytics information, a first group of ML client members to perform the federated learning from the plurality of potential ML client members.

### TECHNICAL FIELD

Embodiments described herein relate to methods and apparatuses for selection of one or more ML client members from a plurality of potential ML client members to perform federated learning.

### BACKGROUND

Generally, all terms used herein are to be interpreted according to their ordinary meaning in the relevant technical field, unless a different meaning is clearly given and/or is implied from the context in which it is used. All references to a/an/the element, apparatus, component, means, step, etc. are to be interpreted openly as referring to at least one instance of the element, apparatus, component, means, step, etc., unless explicitly stated otherwise. The steps of any methods disclosed herein do not have to be performed in the exact order disclosed, unless a step is explicitly described as following or preceding another step and/or where it is implicit that a step must follow or precede another step. Any feature of any of the embodiments disclosed herein may be applied to any other embodiment, wherever appropriate. Likewise, any advantage of any of the embodiments may apply to any other embodiments, and vice versa. Other objectives, features and advantages of the enclosed embodiments will be apparent from the following description.

Artificial Intelligence (AI)/Machine Learning (ML) is being used in a range of application domains across industry sectors. In mobile communications systems, mobile devices (e.g., smartphones, automotive, robots) are increasingly replacing conventional algorithms (e.g., speech recognition, image recognition, video processing) with AI/ML models to enable applications.

In recent years, the AI/ML-based mobile applications are increasingly computation-intensive, memory-consuming and power-consuming. Meanwhile, end devices usually have stringent energy consumption, compute and memory cost limitations for running a complete offline AI/ML inference/leaning/control onboard. The cloud server trains a global model by aggregating local models partially-trained by each end device (e.g. UE). Within each training iteration, a UE performs the training based on the model downloaded from the AI server using the local training data. Then the UE reports the interim training results to the cloud server via 5G uplink (UL) channels. The server aggregates the interim training results from the UEs and updates the global model. The updated global model is then distributed back to the UEs and the UEs can perform the training for the next iteration.

### Distributed/Federated Learning Over 5G System

As introduced in TR 22.874 (V18.2.0), Distributed/Federated Learning over a 5G system is one of three types of AI/ML operation that the 5G system can support.

Nowadays, the smartphone camera has become the most popular tool to shoot image and video, which holds valuable vision data for image recognition model training. For many image recognition tasks, the images/videos collected by mobile devices are essential for training a global model. Federated Learning (FL) is an increasingly widely-used approach for training computer vision and image recognition models.

FIG. 1 illustrates Federated Learning (FL) over a 5G system. In Federated Learning mode, the cloud server trains a global model by aggregating local models partially-trained by each end device (e.g. UE) based on the iterative model averaging. As depicted in FIG. 1, within each training iteration, a UE (or end device) performs the training based on the model downloaded from the AI server using the local training data. Then the UE reports the interim training results (e.g., gradients for the DNN) to the cloud server via 5G uplink (UL) channels. The server aggregates the gradients from the devices, and updates the global model. Next, the updated global model is distributed to the UEs via 5G downlink (DL) channels, and the UEs can perform the training for the next iteration.

FIG. 2 illustrates an iterative Federated Learning procedure. In the Nth training iteration, the device (e.g. a UE) performs training based on the model downloaded from the FL training server using the images/videos collected locally. Then the device reports the Nth-iteration interim training results (e.g., gradients for the DNN) to the server via 5G UL channels. Meanwhile, the global model and training configuration for the (N+1)th iteration are sent to the device. When the server aggregates the gradients from the devices for the Nth iteration, the device performs the training for the (N+1)th iteration. The federated aggregation outputs are used to update the global model, which will be distributed to devices, together with the updated training configuration.

In order to fully utilize the training resources at the device and minimize the training latency, the training pipeline shown in FIG. 2 requires that the training results report for the (N−1)th iteration and the global model/training configuration distribution for the (N+1)th iteration are finished during the device's training process for the Nth iteration. In practice, more relaxing FL timeline may also be considered with sacrificing of the training convergence speed.

It may be desirable to minimize the training time since mobile devices may only stay in an environment for a short period of time. Further, considering the limited storage at a training device, it may not be realistic to require the training device to store a large amount of training data in the memory for a training after it moves outside the environment.

In contrast to decentralized training operated in cloud datacenters, Federated Learning over wireless communications systems may need to be modified to adapt to the variable wireless channel conditions, unstable training resources on mobile devices and the device heterogeneity.

FIG. 3 illustrates an example of a Federated Learning protocol for wireless communications.

For each iteration, the training devices may firstly be selected. The candidate training devices report their computation resource available for the training task to the FL server. The FL server makes the training device selection based on the reports from the devices and other conditions, e.g., the devices'wireless channel conditions, geographic location, etc.

Hereby, besides performing federated learning task, the training devices in a communication system have their other data to transmit at uplink (e.g., for ongoing service transactions), that may be high priority and not latency-tolerant and its transmission may affect a device's ability to upload the locally trained model. Device selection must therefore account for a trade-off to upload the training results compared to uploading other uplink data. Furthermore, excluding a device from federated learning model aggregation for one or more iterations affects the convergence of the federated learning model. Therefore, candidate training device selection over wireless links is more complex than federated learning in data centers.

After the training devices are selected, the FL server will send the training configurations to the selected training devices, together with global model for training. A training device starts training based on the received global model and training configuration. When finishing the local training, a device reports its interim training results (e.g., gradients for the DNN) to the FL server. In FIG. 3, the training device selection is performed, and the training configurations are sent to the training devices at the beginning of each iteration. If the conditions (e.g., device's computation resource, wireless channel condition, other service transactions of the training devices) are not changed, the training device re-selection and training re-configuration might not be needed for each iteration, i.e., the same group of training devices can participate the training with the same configuration for multiple iterations. Still, the selection of training devices should be alternated over time in order to achieve an independent and identically distributed sampling from all devices, in other words, to give a fair chance to all devices to contribute to the aggregated model.

### Application Server Selection

A solution (i.e., solution #45) is given in TR 23.700-80 (V18.3.0) for central application server selection with 5GC's assistance.

This solution addresses the following aspect of Key Issue #7 “5GS Assistance to Federated Learning Operation”in TR 23.700-80 (V18.3.0).
How to assist the AF to improve the FL performance (e.g., to manage latency divergence) among UEs when the application server receives the local ML model training information from different UEs in order to perform a global model update.

In federated learning, an increase of communication delay for any member UE may cause a delay for overall FL progress. In application AI/ML based FL, the member UEs may be served by different application servers.

FIG. 4 illustrates an example in which FL central servers are distributed in different areas. It may be assumed that there is only one central server in each round of FL.

It is obvious that using different application server as FL central server will achieve different performance (e.g., overall packet delay, traffic rate, etc.). To improve the overall performance of FL, how to select appropriate central server of application AI/ML based FL should be considered. The AF may be able to determine the best central server for one or multiple rounds of FL with 5GC's assistance to improve the overall FL performance. During FL operation, due to the member UE's mobility, the AF may be able to change the central server dynamically.

### Procedures

FIG. 5 illustrates an example procedure for FL Central Server Selection

In steps 501, the AF sends Analytics subscription to the NWDAF via NEF. The parameters may include one or more of:
Analytics ID(s) (“DN Performance” is mandatory, “UE Mobility”, “Network Performance” and others are optional);
Member UE(s);
Application ID(s);
Application server instance address(es);
the target time period;
A flag indicating that whether suggested server list is required; and
Other parameters related to the Analytics ID(s)

In step 503, the NWDAF collects data from related NF(s) and derives the analytics. The input data of “DN performance” are mainly provided by the AF. The input data of other Analytics ID (e.g. “UE Mobility”, “Network Performance”) may be provided by other NFs (e.g. AMF, NRF). This may include:
Time delay between member UE(s) and the application servers;
Maximum latency divergence between member UE(s) and different application server;
Traffic rate for member UE(s) communicating with the application servers;
Packet loss rate of communications between member UE(s) and the application servers;
Other results related to the analytics ID(s);

Optionally, the NWDAF derives the suggested list of application server(s) (sorting in descending order) according to the above analytics based on the AF's requirement in step 1.

In steps 504 to 505, the NWDAF sends an analytics report or the suggested list of application server(s) to the AF via NEF.

In step 506, the AF selects the best application server as the FL central server based on local internal logic and the analytics results or the suggested list received from NWDAF. The AF may update the subscription to NWDAF based on the final decision.

In step 507, optionally, the AF may send policy related information (e.g. AM or SM policies related information) to PCF.

In step 508, the AF sends notify to the selected central server with the FL related information. The central server starts FL with the member UE(s).

In steps 509-510, the NWDAF may continuously send new analytics report or new suggested list of application sever(s) based on the subscription of the AF in step 1.

In step 511, the AF may reselect the central server based on local internal logic and information received from NWDAF.

In step 512, if the central server changed, the AF sends notify to the original server and the new central server. The original central server then sends the FL context to the new central server. The new central server continues the FL with member UE(s).

NOTE: How the new central server obtains the FL context may be determined by the AF.

### SUMMARY

According to some embodiments there is provided a method, in an application function for selection of one or more ML client members from a plurality of potential ML client members to perform federated learning. The method comprises responsive to commencement of the federated learning, obtaining first analytics information relating to communication performance between potential groups of ML servers and a plurality of potential ML client members; and selecting, based on the first analytics information, a first group of ML client members to perform the federated learning from the plurality of potential ML client members.

According to some embodiments there is provided a method, in a network data analytics function, NWDAF, for assisting in selection of one or more machine learning, ML, client members from a plurality of potential ML client members to perform federated learning. The method comprises responsive to commencement of the federated learning, receiving, from an application function, a second subscription request to assist ML client member selection; responsive to the second subscription request, generating first analytics information relating to communication performance between potential groups of ML servers and a plurality of potential ML client members; and transmitting the first analytics information to the application function.

According to some embodiments there is provided an application function for selection of one or more machine learning, ML, client members from a plurality of potential ML client members to perform federated learning. The application function comprises processing circuitry configured to cause the application function to: responsive to commencement of the federated learning, obtain first analytics information relating to communication performance between potential groups of ML servers and a plurality of potential ML client members; and select, based on the first analytics information, a first group of ML client members to perform the federated learning from the plurality of potential ML client members.

According to some embodiments there is provided a network data analytics function, NWDAF, for assisting in selection of one or more machine learning, ML, client members from a plurality of potential ML client members to perform federated learning. The NWDAF comprises processing circuitry configured to cause the NWDAF to: responsive to commencement of the federated learning, receive, from an application function, a second subscription request to assist ML client member selection; responsive to the second subscription request, generate first analytics information relating to communication performance between potential groups of ML servers and a plurality of potential ML client members; and transmit the first analytics information to the application function.

For the purposes of the present disclosure, the term “ML model” encompasses within its scope the following concepts:
Machine Learning algorithms, comprising processes or instructions through which data may be used in a training process to generate a model artefact for performing a given task, or for representing a real world process or system;
the model artefact that is created by such a training process, and which comprises the computational architecture that performs the task; and
the process performed by the model artefact in order to complete the task.

References to “ML model”, “model”, “model parameters”, “model information”, etc., may thus be understood as relating to any one or more of the above concepts encompassed within the scope of “ML model”.

### BRIEF DESCRIPTION OF THE DRAWINGS

For a better understanding of the embodiments of the present disclosure, and to show how it may be put into effect, reference will now be made, by way of example only, to the accompanying drawings, in which:

FIG. 1 illustrates Federated Learning (FL) over a 5G system;

FIG. 2 illustrates an iterative Federated Learning procedure;

FIG. 3 illustrates an example of a Federated Learning protocol for wireless communications;

FIG. 4 illustrates an example in which FL central servers are distributed in different areas;

FIG. 5 illustrates an example procedure for FL Central Server Selection;

FIG. 6 illustrates a system for 5GC assisting joint ML server-client selection for AI/ML operations in an AI/ML process;

FIG. 7 illustrates a system for the 5GC to assist in joint ML server and client members selection for the AI/ML operations in an AI/ML process;

FIG. 8 illustrates a method, in an application function for selection of one or more ML client members from a plurality of potential ML client members to perform federated learning;

FIG. 9 illustrates a method, in a network data analytics function (NWDAF), for assisting in selection of one or more ML client members from a plurality of potential ML client members to perform federated learning;

FIG. 10 illustrates an example implementation of the methods of FIGS. 8 and 9;

FIG. 11 illustrates an example implementation of the methods of FIGS. 8 and 9;

FIG. 12 illustrates an application function comprising processing circuitry (or logic);

FIG. 13 is a block diagram illustrating an application function according to some embodiments;

FIG. 14 illustrates an NWDAF comprising processing circuitry (or logic); and

FIG. 15 is a block diagram illustrating an NWDAF according to some embodiments.

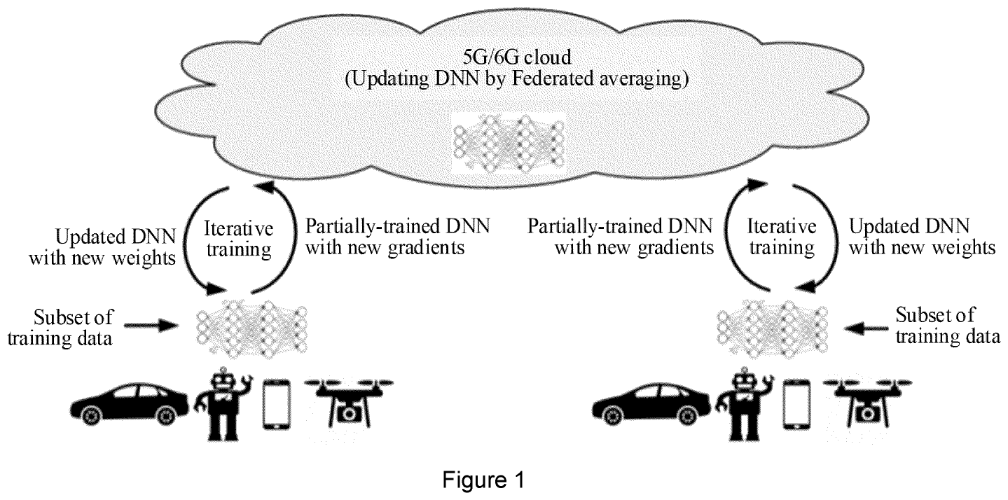

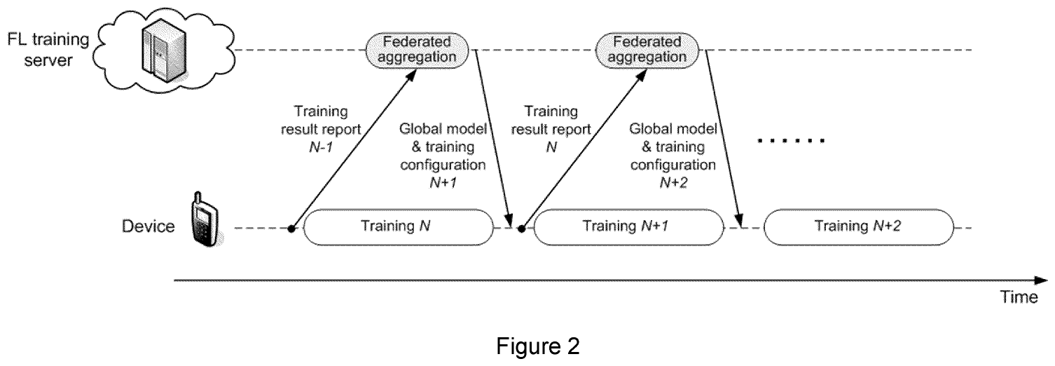

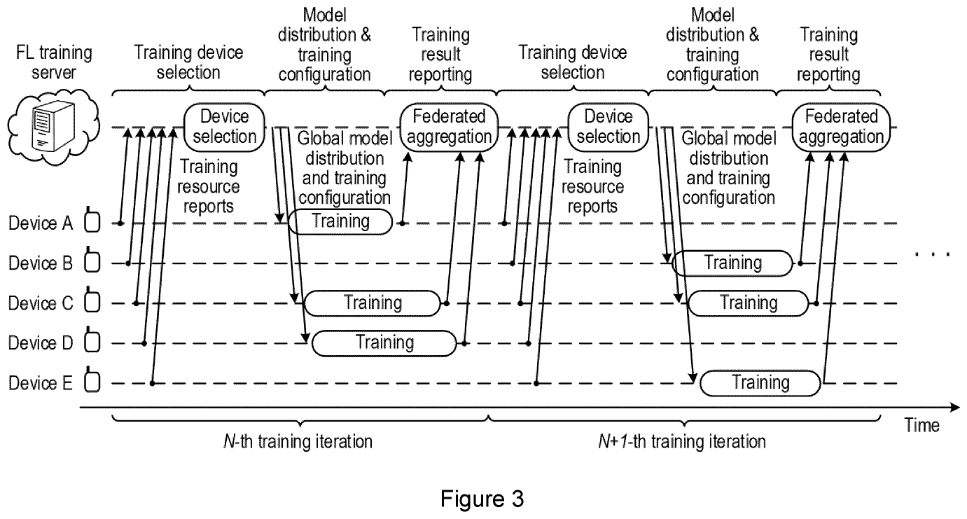

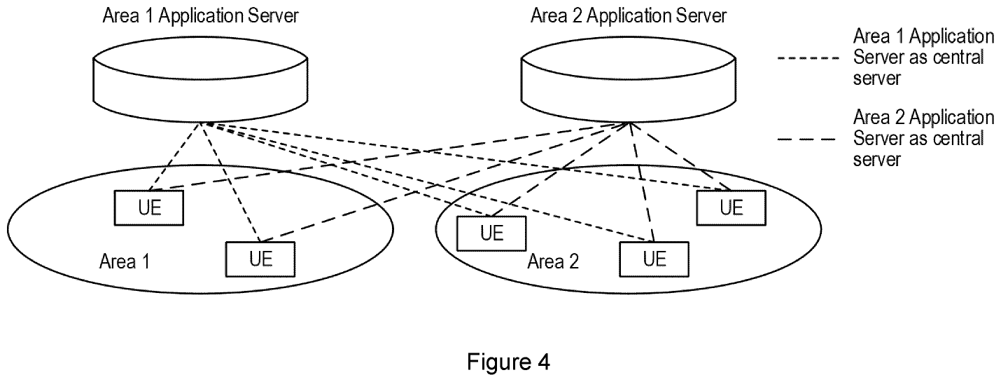

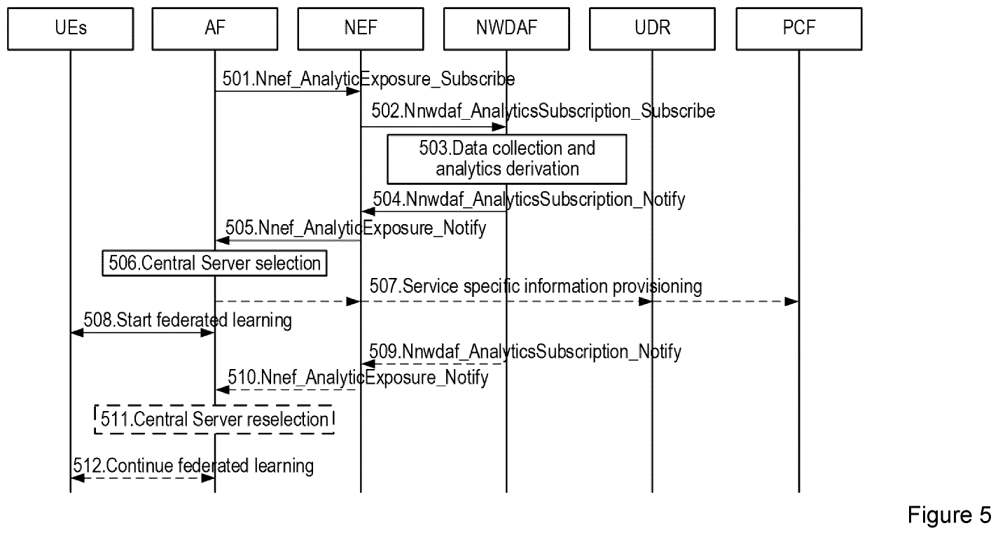

### DESCRIPTION

The following sets forth specific details, such as particular embodiments or examples for purposes of explanation and not limitation. It will be appreciated by one skilled in the art that other examples may be employed apart from these specific details. In some instances, detailed descriptions of well-known methods, nodes, interfaces, circuits, and devices are omitted so as not obscure the description with unnecessary detail. Those skilled in the art will appreciate that the functions described may be implemented in one or more nodes using hardware circuitry (e.g., analog and/or discrete logic gates interconnected to perform a specialized function, ASICs, PLAs, etc.) and/or using software programs and data in conjunction with one or more digital microprocessors or general purpose computers. Nodes that communicate using the air interface also have suitable radio communications circuitry. Moreover, where appropriate the technology can additionally be considered to be embodied entirely within any form of computer-readable memory, such as solid-state memory, magnetic disk, or optical disk containing an appropriate set of computer instructions that would cause a processor to carry out the techniques described herein.

Hardware implementation may include or encompass, without limitation, digital signal processor (DSP) hardware, a reduced instruction set processor, hardware (e.g., digital or analogue) circuitry including but not limited to application specific integrated circuit(s) (ASIC) and/or field programmable gate array(s) (FPGA(s), and (where appropriate) state machines capable of performing such functions.

Some of the embodiments contemplated herein will now be described more fully with reference to the accompanying drawings. Embodiments are provided by way of example to convey the scope of the subject matter to those skilled in the art. Additional information may also be found in the document(s) provided in the Appendix.

As described above, the server and client members for the AI/ML operations in an AI/ML process are dynamically changed, e.g., server member(s) may change due to the movement of client members, and the client members may need be reselected due to the movement of client members in various directions to different areas, the dynamic changed behaviour and status of client members, and the changes of connections and interactions between server member(s) and client members. Existing solutions consider the selection of server members and client members separately in an AI/ML process, and consider only one server in each round of ML.

Embodiments described herein extend the existing Analytics ID for assisting the joint server-client member selection. ML server and client members are changed either alternatively or simultaneously for the AI/ML operations in an AI/ML process.

In embodiments described herein extending of the existing Analytics ID (e.g., DN Performance, UE Mobility, Abnormal behaviour, Network Performance, etc.) is proposed to provide analytics for assisting joint and dynamic ML server and client member selections. Example procedures of joint ML server and client member selection for AI/ML operations in an AI/ML process are given.

The new analytics inputs of the extended Analytics ID may be
ML server(s)
ML client member(s), e.g., UE(s)
Indication of whether suggested list of ML servers is required
Indication of whether suggested list of ML client members is required
Period of analytics update for ML server(s)
Period of analytics update for ML client member(s) The new analytics outputs of the extended Analytics ID may be
Statistics/predictions on communication performance between a group of ML client members and a single ML server
Statistics/predictions on communication performance between a group of ML servers and a single ML client member
Statistics/predictions on communication performance between a group of ML client members and a group of ML servers
Predictions/recommendation on ML server list
Predictions/recommendation on ML client member list The procedures for joint ML server and client member selection may include
Perform the selection of ML server and client member simultaneously
Perform the selection of ML server and client member alternatively

Embodiments described herein propose to extend the existing Analytics ID (e.g., DN Performance, UE Mobility, Abnormal behaviour, Network Performance, etc.) to provide analytics for assisting the joint and dynamic ML server and client member selections. New inputs are applied to generate the corresponding new outputs of the extended Analytics ID. The new outputs are used for assisting the joint ML server and client member selections for AI/ML operations. Example corresponding procedures for joint ML server and client member selection being performed either alternatively or simultaneously are given.

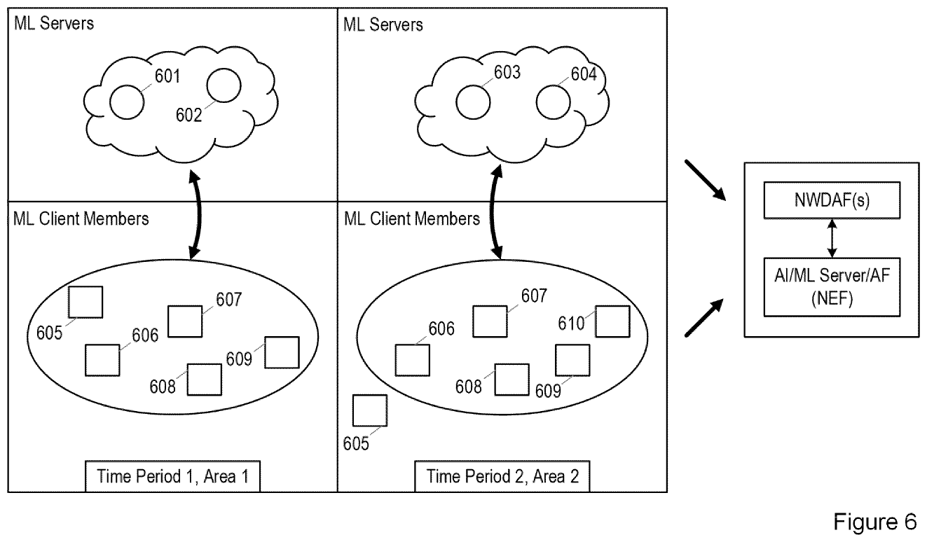

FIG. 6 illustrates a system for 5GC assisting joint ML server-client selection for AI/ML operations in an AI/ML process.

In this example, the ML servers 601 to 604 comprise potential ML servers that could be used to perform the FL. In this example, the ML servers 601 and 602 form a first group of ML servers, and the ML servers 603 and 604 form a second group of ML servers. It will be appreciate that a group of ML servers may comprise one or more servers.

The ML client members 605 to 610 comprise potential ML client members that could be used to perform the FL.

As shown in FIG. 6, multiple ML client members (e.g., UEs) connect to multiple ML servers for the AI/ML operations of an AI/ML process. In time period 1, a first group of ML client members (e.g. client members 605 to 609) are connected to the first group of ML servers (e.g. servers 601 and 602).

Due to the mobility of the client members, for example from area 1 to area 2, the communication performance between the ML client members 605 to 609 and the ML servers 601 and 602 deteriorates. In order to complete the AI/ML operations accurately and quickly, improvement of the communication performance between the ML clients and servers may be required. Thus, the ML servers may be reselected, for example, in time period 2, the second group of ML servers (e.g. ML servers 603 and 604) in area 2 may be selected.

In conjunction with the changes of group of ML servers, re-selection of ML client members may be needed to achieve good communication performance. In this example, in time period 2 and area 2, a second group of ML client members (e.g. ML client members 606 to 611) are selected to connect to the second group of ML servers (e.g. ML servers 603 and 604).

As the ML client members keep moving, the ML servers and ML client members for the AI/ML operations of an AI/ML process may need to be changed continuously with time. The 5GC system may assist the joint ML server-client selection. The existing Analytics ID (e.g., DN Performance, UE Mobility, Abnormal behavior, Network Performance, etc.) may be extended to provide analytics for assisting the joint ML server and client member selections.

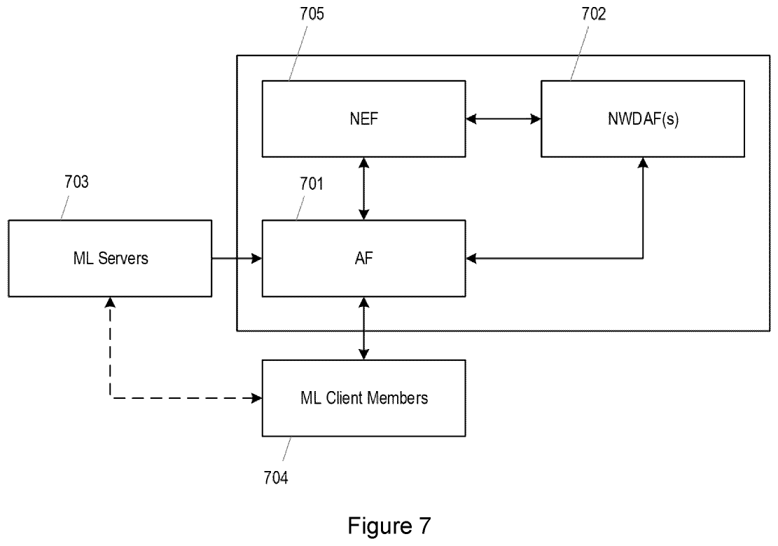

FIG. 7 illustrates a system for the 5GC to assist in joint ML server and client members selection for the AI/ML operations in an AI/ML process.

The AF 701 requests/subscribes to one or multiple NWDAF(s) 702 for analytics to generate AI/ML assistance information for ML server 703 and ML client member 704 selection. The AI/ML assistance information is used at the AF 701 to determine the ML servers 703 and ML client members 704 to use. The Analytics ID (e.g., DN Performance, UE Mobility, Abnormal behavior, Network Performance, etc.) may be contained in the requests from the AF (or via NEF 705).

The extended Analytics ID (e.g., DN Performance, UE Mobility, Abnormal behavior, Network Performance, etc.) provide analytics for assisting joint and dynamic ML server and client member selections. The new analytics inputs of the extended Analytics ID may be
ML server(s)
ML client member(s), e.g., UE(s)
Indication of whether suggested list of ML servers is required
Indication of whether suggested list of ML client members is required
Period of analytics update for ML server(s)
Period of analytics update for ML client member(s) The new analytics outputs of the extended Analytics ID may be
Statistics/predictions on communication performance between a group of ML client members and a single ML server
Statistics/predictions on communication performance between a group of ML servers and a single ML client member
Statistics/predictions on communication performance between a group of ML client members and a group of ML servers
Predictions/recommendation on ML server list
Predictions/recommendation on ML client member list The procedures for joint ML server and client member selection may include
Perform the selection of ML server and client member simultaneously
Perform the selection of ML server and client member alternatively If the AF 701 is in trusted domain, it may be configured to interact with the NFs in 5GC (e.g., NWDAF(s) 702) directly. If AF 701 is in untrusted domain, it may be configured to interact with the NFs in 5GC via the Network Exposure Function (NEF) 705.

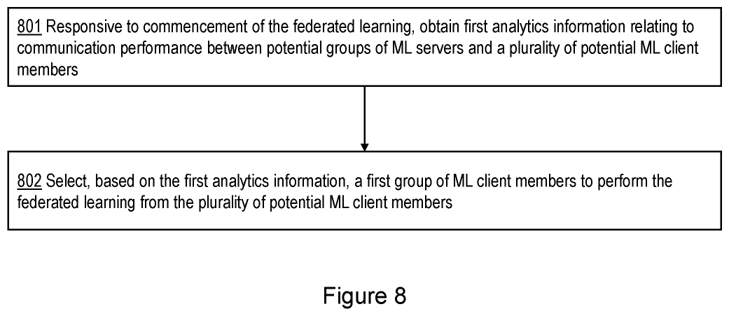

FIG. 8 illustrates a method, in an application function for selection of one or more ML client members from a plurality of potential ML client members to perform federated learning. It will be appreciated that the method of FIG. 8 may be performed by the AF 701 illustrated in FIG. 7.

The method 800 may be performed by a network function (e.g. an application function), which may comprise a physical or virtual node, and may be implemented in a computing device or server apparatus and/or in a virtualized environment, for example in a cloud, edge cloud or fog deployment.

In step 801 the method comprises, responsive to commencement of the federated learning, obtaining first analytics information relating to communication performance between potential groups of ML servers and a plurality of potential ML client members.

In step 802 the method comprises selecting, based on the first analytics information, a first group of ML client members to perform the federated learning from the plurality of potential ML client members.

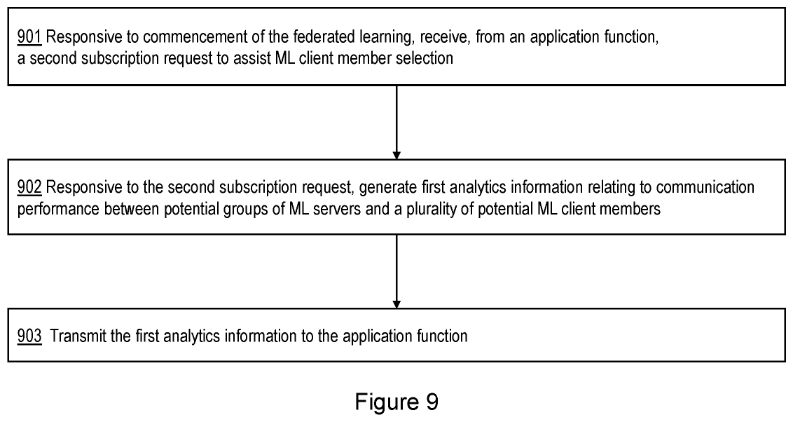

FIG. 9 illustrates a method, in a network data analytics function (NWDAF), for assisting in selection of one or more ML client members from a plurality of potential ML client members to perform federated learning. It will be appreciated that the method of FIG. 9 may be performed by the NWDAF 702 illustrated in FIG. 7.

The method 900 may be performed by a network function (e.g. an NWDAF), which may comprise a physical or virtual node, and may be implemented in a computing device or server apparatus and/or in a virtualized environment, for example in a cloud, edge cloud or fog deployment.

In step 901, the method comprises responsive to commencement of the federated learning, receiving, from an application function, a second subscription request to assist ML client member selection.

In step 902 the method comprises, responsive to the second subscription request, generating first analytics information relating to communication performance between potential groups of ML servers and a plurality of potential ML client members.

In step 903 the method comprises transmitting the first analytics information to the application function.

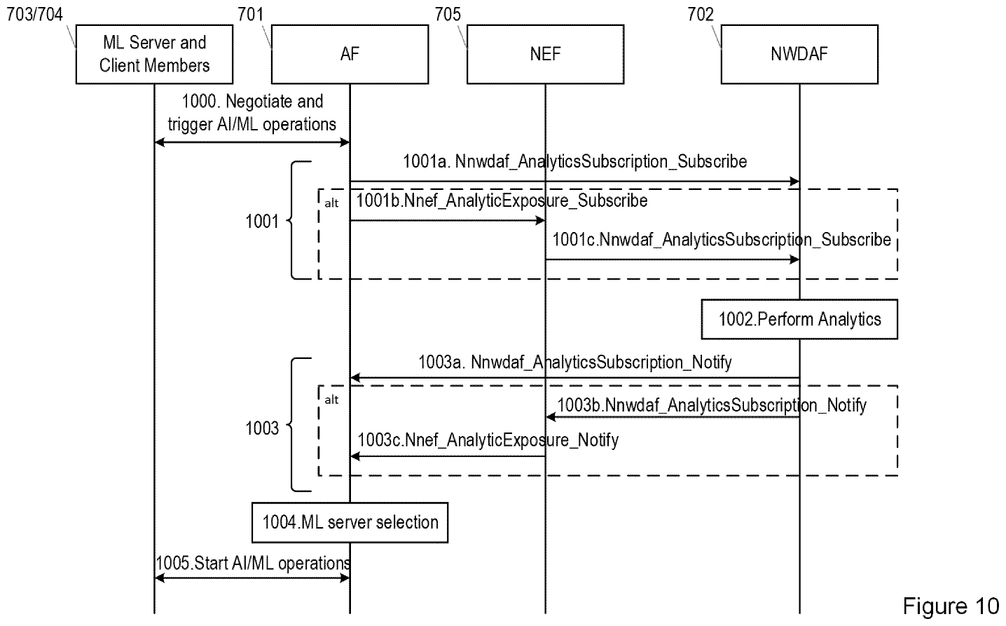

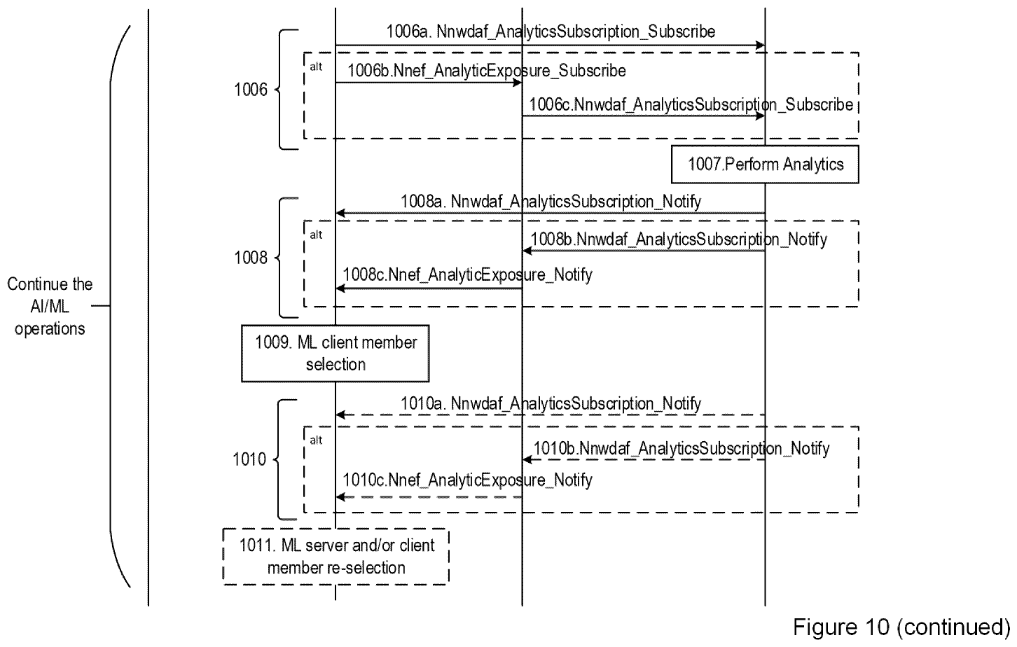

FIG. 10 illustrates an example implementation of the methods of FIGS. 8 and 9.

In particular, FIG. 10 illustrates an example procedure for the 5GC system to assist joint ML server and client members selection simultaneously.

Steps 1000 to 1004 take place prior to commencement of the federated learning.

In step 1000, an ML server and/or client member 703/704 (e.g. a UE) and an AF 701 negotiate and trigger AI/ML operations for an AI/ML process.

In particular, the ML server and/or client members 703/704 may transmit a request for an AI/ML process to the AF 701. For example, the request may comprise a request to initiate performance of federated learning, FL.

The following information may be contained in the request of step 1000:
An indication that joint ML server and client member selection should be performed simultaneously or alternatively;
(If known) Time intervals for ML server selections;
(if Known) Time intervals for ML client member selections

In step 1001 an AF 701 transmits a first subscription request to one or multiple NWDAF(s) 702. This first subscription request may be made directly to the NWDAF 702 as illustrated in step 1001a or via an NEF 705 as shown in steps 1001b-1001c.

The first subscription request may be for analytics of the Analytics ID (e.g., DN Performance, UE Mobility, Abnormal behaviour, Network Performance, etc.) to assist ML server selection. Beside the other information/parameters, the first subscription request to the NWDAF 702 may comprise one or more of the following:
An indication of ML server(s) (e.g. potential ML server(s))
An indication of ML client member(s), (e.g. initial client members)
An indication of whether a suggested list of ML servers is required
A Time period of analytics update for ML server(s)

In step 1002, the NWDAF(s) 702 performs operations to generate the second analytics information.

For example, step 1002 may comprise the NWDAF 702, responsive to receiving the first subscription request, generating second analytics information relating to communication performance between potential groups of the ML servers and the initial ML client members

The second analytics information may comprise one or more of:
Statistics/predictions on communication performance between a group of potential ML client members and a single potential ML server
Statistics/predictions on communication performance between a group of ML client members and a group of ML servers
Predictions/recommendation on ML server list

In step 1003 the NWDAF 702 may transmit the second analytics information to the AF 701. For example, The NWDAF(s) 702 may informs the AF 701 (e.g. directly as illustrated in step 1003a or via NEF 705 as shown in steps 1003b-1003c) with the second analytics information.

In step 1004, the AF 701 selects a first group of ML servers 703 based on the second analytics information. For example, the AF 701 performs ML server selection based on the information from the ML server and client members and the received second analytics information from the NWDAF(s) 702.

In step 1005, the method comprises commencing federated learning using the first group of ML servers and the initial ML client members. In other words, the AI/ML operations are started.

In step 1006, the AF 701 transmits a second subscription request to one or multiple NWDAF(s) 702 (e.g. either directly as illustrated in step 1006a, or via NEF 705 as shown in steps 1006b-1006c) for analytics of the Analytics ID (e.g., DN Performance, UE Mobility, Abnormal behaviour, Network Performance, etc.) to assist ML client member selection. For example, step 1006 may comprise updating the first subscription request with a second subscription request to assist ML client member selection.

Step 1006 may comprise an example implementation of step 901 of FIG. 9.

Beside other information/parameters, the second subscription request may comprise one or more of the following:
An indication of potential ML server(s)
An indication of potential ML client member(s), e.g., UE(s)
An indication of whether suggested list of ML client members is required
A time period for analytics update for ML client members

In step 1007, the NWDAF(s) 702 responsive to the second subscription request, generates first analytics information relating to communication performance between potential groups of ML servers and a plurality of potential ML client members. Step 1007 may comprise an example implementation of step 902 of FIG. 9. For example, the NWDAF(s) performs operations to generate the required first analytics information. The first analytics information may comprise one or more of:
statistics and/or predictions relating to communication performance between a potential group of ML servers and one of the potential ML client members;
statistics and/or predictions relating to communication performance between a group of potential ML client members and a potential group of ML servers; and
a prediction and/or recommendation of a ML client member list.

In step 1008, the NWDAF 702 transmits the first analytics information to the AF 701. Step 1008 comprises an example implementation of step 903 of FIG. 9. For example, the NWDAF(s) 702 informs the AF 701 (e.g. directly as illustrated in step 1008a or via NEF 705 as shown in steps 1008b-1008c) with the first analytics information.

Steps 1006 to 1008 may be considered to comprise an example implementation of step 801 of FIG. 8.

In step 1009, the AF 701 performs ML client member selection based on the information from the ML server and client members and the received analytics from the NWDAF(s). For example, the AF selects, based on the first analytics information, a first group of ML client members to perform the federated learning from the plurality of potential ML client members. Step 1009 comprises an example implementation of step 802 of FIG. 8.

In step 1010, the NWDAF(s) 702 keep informing the AF 701 with any updated analytics information. For example, the NWDAF 702 may transmit third analytics information periodically according to a time period of analytics update for the ML server and client (e.g. received in steps 1001 and 1006). The third analytics information may be transmitted directly to the AF as illustrated in step 1010a or via the NEF 705 as illustrated in steps 1010b and 1010c.

The third analytics information may comprise one or more of:
Updated statistics/predictions on communication performance between a group of potential ML client members and a potential ML server
Updated statistics/predictions on communication performance between a potential group of ML servers and a one of the potential ML client members
Updated statistics/predictions on communication performance between a group of potential ML client members and a potential group of ML servers
Updated predictions/recommendation on ML server list
Updated predictions/recommendation on ML client member list

In step 1011, the AF 701 performs ML server and client member selection jointly based on the information from the ML server and client members and the received third analytics information from the NWDAF(s) 702. For example, step 11 may comprise: selecting, based on the third analytics information, a second group of ML client members to perform the federated learning; and selecting, based on the third analytics information, a second group of ML servers to perform the federated learning. It will be appreciated that the AF 701 may repeatedly select the same group of ML client members or group of ML servers, or may select overlapping groups.

Note: Steps 1010 and 1011 may continue until a terminate request is received at the NWDAF 702/AF 701. The AI/ML operations (e.g. the FL) keep running during the performance of steps 1006-1011.

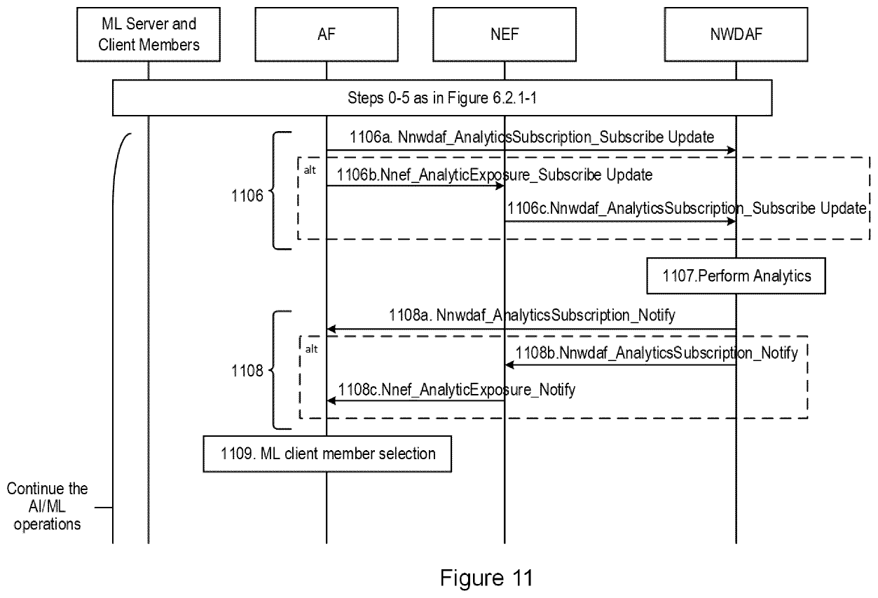

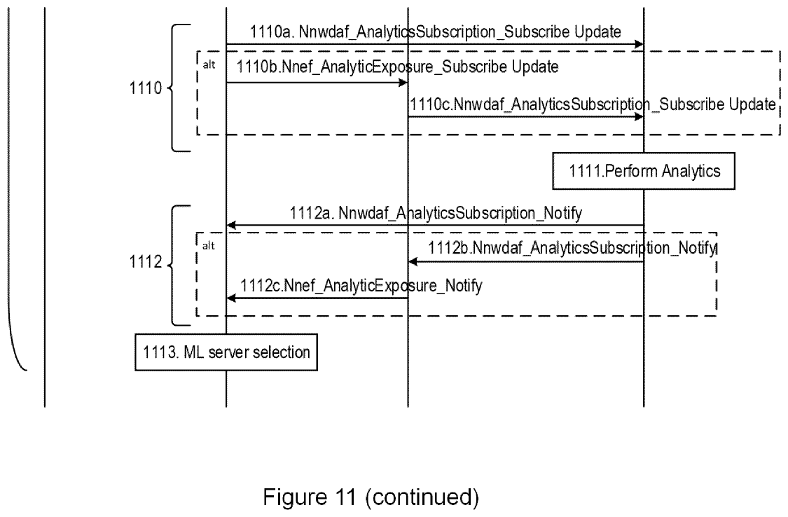

FIG. 11 illustrates an example implementation of the methods of FIGS. 8 and 9.

In particular, FIG. 11 illustrates an example procedure for a 5GC system to assist in joint ML server and client members selection alternatively.

Steps 1100 to 1105 correspond to steps 1000 to 1005 of FIG. 10.

In step 1106, the AF 701 transmits a second subscription request to one or multiple NWDAF(s) 702 (e.g. either directly as illustrated in step 1106a or via NEF 705 as shown in steps 1106b-1106c) for analytics of the Analytics ID (e.g., DN Performance, UE Mobility, Abnormal behaviour, Network Performance, etc.) to assist ML client member selection. For example, step 1106 may comprise updating the first subscription request with a second subscription request to assist ML client member selection.

Step 1106 may comprise an example implementation of step 901 of FIG. 9.

Beside other information/parameters, the second subscription request may comprise one or more of the following:
An indication of a most recently selected group of ML servers, for example, the latest selected ML server(s) in step 4.
An indication of potential ML client member(s), e.g., UE(s)
An indication of whether suggested list of ML client members is required
A time period for analytics update for ML client members

In step 1107, the NWDAF(s) 702 responsive to the second subscription request, generates first analytics information relating to communication performance between the most recently selected group of ML servers and a plurality of potential ML client members. Step 1107 may comprise an example implementation of step 902 of FIG. 9. For example, the NWDAF(s) 702 performs operations to generate the required first analytics information. The first analytics information may comprise one or more of:
statistics and/or predictions relating to communication performance between the most recently selected group of ML servers and one of the potential ML client members;
statistics and/or predictions relating to communication performance between a group of potential ML client members and the most recently selected group of ML servers; and
a prediction and/or recommendation of a ML client member list.

In step 1108, the NWDAF 702 transmits the first analytics information to the application function. Step 1108 may comprise an example implementation of step 903 of FIG. 9.

For example, the NWDAF(s) 702 informs the AF 701 (e.g. either directly as illustrated in step 1108a or via NEF 705 as shown in steps 1108b-1108c) with the first analytics information.

Steps 1106 to 1108 may be considered to comprise an example implementation of step 801 of FIG. 8.

In step 1109, the AF 701 performs ML client member selection based on the information from the ML server and client members 703/704 and the received analytics from the NWDAF(s) 702. Step 1109 may be considered to comprise an example implementation of step 802 of FIG. 8. For example, the AF 701 selects, based on the first analytics information, a first group of ML client members to perform the federated learning from the plurality of potential ML client members.

In step 1110, the AF 701 may update the second subscription request with a third subscription request to assist selection of ML servers. For example, the AF 701 may update the subscription to the NWDAF(s) (e.g. either directly as illustrated in step 1110a or via NEF as shown in steps 1110b-1110c).

The third subscription request comprises, beside the other information/parameters, on or more of the following:
an indication of potential ML server(s)
An indication of a most recently selected group of ML client members. For example, the latest selected ML client member(s), e.g., UE(s), in step 9.
An indication of whether suggested list of ML server is required
A time period for analytics update for ML servers

In step 1111, the NWDAF(s) 702 generates third analytics information relating to communication performance between groups of potential ML servers and a plurality of potential ML client members. In particular, the third analytics information relates to communication performance between the potential groups of ML servers and most recently selected group of ML client members.

For example, the third analytics information may comprise one or more of:
Statistics/predictions on communication performance between the most recently selected group of ML client members and one of the potential ML servers
Statistics/predictions on communication performance between the most recently selected group of ML client members and a group of ML servers; and
Predictions/recommendations for a ML server list

In step 1112, the NWDAF 702 transmits the third analytics information to the AF. For example, the NWDAF(s) 702 informs the AF 701 (e.g. either directly as illustrated in step 1112a or via an NEF 705 as shown in steps 1112b-1112c) with the third analytics information.

In step 1113, the AF 701 selects, based on the obtained third analytics information, a second group of ML servers to perform the federated learning. For example, the AF 701 may perform ML server selection based on the information from the ML server and client members and the received third analytics information from the NWDAF(s).

Note: Steps 1106-1113 may be repeated until a terminate request is received at the NWDAF 702/AF 701. The AI/ML operations (e.g. FL) may be continued during the performance of steps 1106-1113.

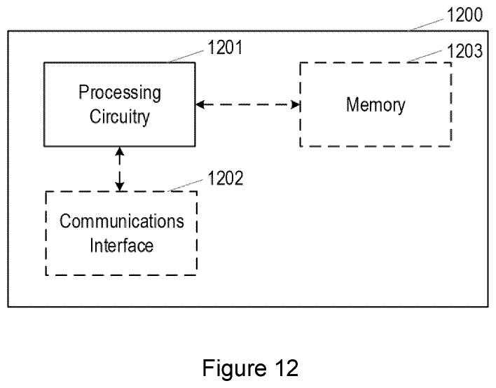

FIG. 12 illustrates an application function 1200 comprising processing circuitry (or logic) 1201. The processing circuitry 1201 controls the operation of the application function 1200 and can implement the method described herein in relation to an application function 1200. The processing circuitry 1201 can comprise one or more processors, processing units, multi-core processors or modules that are configured or programmed to control the application function 1200 in the manner described herein. In particular implementations, the processing circuitry 1201 can comprise a plurality of software and/or hardware modules that are each configured to perform, or are for performing, individual or multiple steps of the method described herein in relation to the application function 1200.

Briefly, the processing circuitry 1201 of the application function 1200 is configured to: responsive to commencement of the federated learning, obtain first analytics information relating to communication performance between potential groups of ML servers and a plurality of potential ML client members; and select, based on the first analytics information, a first group of ML client members to perform the federated learning from the plurality of potential ML client members.

In some embodiments, the application function 1200 may optionally comprise a communications interface 1202. The communications interface 1202 of the application function 1200 can be for use in communicating with other nodes, such as other virtual nodes. For example, the communications interface 1202 of the application function 1200 can be configured to transmit to and/or receive from other nodes requests, resources, information, data, signals, or similar. The processing circuitry 1201 of application function 1200 may be configured to control the communications interface 1202 of the application function 1200 to transmit to and/or receive from other nodes requests, resources, information, data, signals, or similar.

Optionally, the application function 1200 may comprise a memory 1203. In some embodiments, the memory 1203 of the application function 1200 can be configured to store program code that can be executed by the processing circuitry 1201 of the application function 1200 to perform the method described herein in relation to the application function 1200. Alternatively or in addition, the memory 1203 of the application function 1200, can be configured to store any requests, resources, information, data, signals, or similar that are described herein. The processing circuitry 1201 of the application function 1200 may be configured to control the memory 1203 of the application function 1200 to store any requests, resources, information, data, signals, or similar that are described herein.

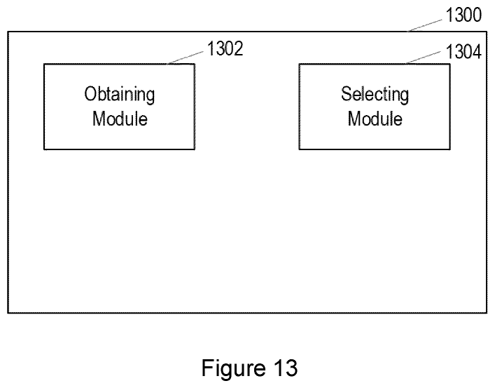

FIG. 13 is a block diagram illustrating an application function 1300 according to some embodiments. The application function 1300 may select one or more machine learning, ML, client members from a plurality of potential ML client members to perform federated learning. The application function 1300 comprises an obtaining module 1302 configured to responsive to commencement of the federated learning, obtain first analytics information relating to communication performance between potential groups of ML servers and a plurality of potential ML client members. The application function 1300 comprises a selecting module 1304 configured to select, based on the first analytics information, a first group of ML client members to perform the federated learning from the plurality of potential ML client members. The application function 1300 may operate in the manner described herein in respect of an application function.

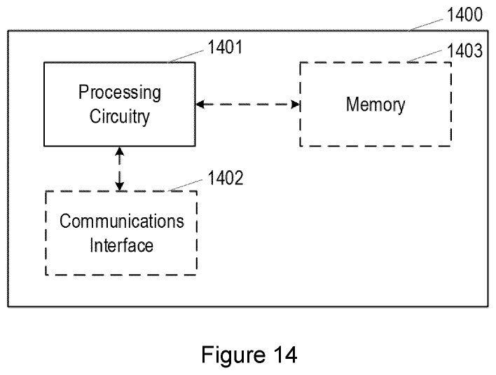

FIG. 14 illustrates an NWDAF 1400 comprising processing circuitry (or logic) 1401. The processing circuitry 1401 controls the operation of the NWDAF 1400 and can implement the method described herein in relation to an NWDAF 1400. The processing circuitry 1401 can comprise one or more processors, processing units, multi-core processors or modules that are configured or programmed to control the NWDAF 1400 in the manner described herein. In particular implementations, the processing circuitry 1401 can comprise a plurality of software and/or hardware modules that are each configured to perform, or are for performing, individual or multiple steps of the method described herein in relation to the NWDAF 1400.

Briefly, the processing circuitry 1401 of the NWDAF 1400 is configured to: responsive to commencement of the federated learning, receive, from an application function, a second subscription request to assist ML client member selection; responsive to the second subscription request, generate first analytics information relating to communication performance between potential groups of ML servers and a plurality of potential ML client members; and transmit the first analytics information to the application function.

In some embodiments, the NWDAF 1400 may optionally comprise a communications interface 1402. The communications interface 1402 of the NWDAF 1400 can be for use in communicating with other nodes, such as other virtual nodes. For example, the communications interface 1402 of the NWDAF 1400 can be configured to transmit to and/or receive from other nodes requests, resources, information, data, signals, or similar. The processing circuitry 1401 of NWDAF 1400 may be configured to control the communications interface 1402 of the NWDAF 1400 to transmit to and/or receive from other nodes requests, resources, information, data, signals, or similar.

Optionally, the NWDAF 1400 may comprise a memory 1403. In some embodiments, the memory 1403 of the NWDAF 1400 can be configured to store program code that can be executed by the processing circuitry 1401 of the NWDAF 1400 to perform the method described herein in relation to the NWDAF 1400. Alternatively or in addition, the memory 1403 of the NWDAF 1400, can be configured to store any requests, resources, information, data, signals, or similar that are described herein. The processing circuitry 1401 of the NWDAF 1400 may be configured to control the memory 1403 of the NWDAF 1400 to store any requests, resources, information, data, signals, or similar that are described herein.

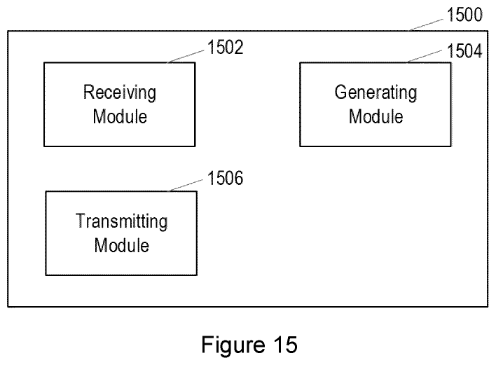

FIG. 15 is a block diagram illustrating an NWDAF 1500 according to some embodiments. The NWDAF 1500 may assist in selecting one or more machine learning, ML, client members from a plurality of potential ML client members to perform federated learning. The NWDAF 1500 comprises a receiving module 1502 configured to responsive to commencement of the federated learning, receive, from an application function, a second subscription request to assist ML client member selection. The NWDAF 1500 comprises a generating module 1504 configured to responsive to the second subscription request, generate first analytics information relating to communication performance between potential groups of ML servers and a plurality of potential ML client members. The NWDAF comprises a transmitting module 1506 configured to transmit the first analytics information to the application function. The NWDAF 1500 may operate in the manner described herein in respect of an NWDAF.

There is also provided a computer program comprising instructions which, when executed by processing circuitry (such as the processing circuitry 1201 of the application function 1200 described earlier), cause the processing circuitry to perform at least part of the method described herein. There is provided a computer program product, embodied on a non-transitory machine-readable medium, comprising instructions which are executable by processing circuitry to cause the processing circuitry to perform at least part of the method described herein. There is provided a computer program product comprising a carrier containing instructions for causing processing circuitry to perform at least part of the method described herein. In some embodiments, the carrier can be any one of an electronic signal, an optical signal, an electromagnetic signal, an electrical signal, a radio signal, a microwave signal, or a computer-readable storage medium.

Due to the mobility of ML client members (e.g. UE(s)), the ML server and ML client members may change alternatively/simultaneously for the AI/ML operations in an AI/ML process. The new analytics outputs of extended Analytics ID may be used to assist the joint ML server-client member selection. Different from the existing solutions, in which ML server and client members are selected separately, joint ML server-client member selection adapts to the dynamic environment changes better and may complete the AI/ML operations more accurately and quickly.

It should be noted that the above-mentioned embodiments illustrate rather than limit the invention, and that those skilled in the art will be able to design many alternative embodiments without departing from the scope of the appended claims. The word “comprising” does not exclude the presence of elements or steps other than those listed in a claim, “a” or “an” does not exclude a plurality, and a single processor or other unit may fulfil the functions of several units recited in the claims. Any reference signs in the claims shall not be construed so as to limit their scope.

1. A method, in an application function for selection of one or more machine learning (ML) client members from a plurality of potential ML client members to perform federated learning, the method comprising:
responsive to commencement of the federated learning, obtaining first analytics information relating to communication performance between potential groups of ML servers and a plurality of potential ML client members; and
selecting, based on the first analytics information, a first group of ML client members to perform the federated learning from the plurality of potential ML client members.

2. The method according to claim 1, wherein the first analytics information comprises one or more of:
statistics and/or predictions relating to communication performance between a potential groups of ML servers and one of the potential ML client members;
statistics and/or predictions relating to communication performance between a potential group of ML client members and a potential group of ML servers; and
a prediction and/or recommendation of a ML client member list.

3. The method according to claim 1, further comprising:
transmitting a first subscription request to one or more network data analytics functions (NWDAFs) to assist ML server selection, the first subscription request comprising
an indication of the potential ML servers; and
an indication of initial ML client members;
an indication of whether a suggested list of ML servers is required; and/or
a time period for analytics update for ML server(s).

4. (canceled)

5. The method according to claim 3, further comprising:
responsive to transmitting the first subscription request, receiving second analytics information from the NWDAFs relating to communication performance between potential groups of the ML servers and the initial ML client members;
selecting a first group of ML servers based on the second analytics information; and
commencing federated learning using the first group of ML servers and the initial ML client members.

6. (canceled)

7. The method according to claim 1, wherein the step of obtaining the first analytics information comprises:
updating the first subscription request with a second subscription request to assist ML client member selection, wherein the second subscription request comprises an indication of a most recently selected group of ML servers.

8. (canceled)

9. The method according to claim 7, wherein the second subscription request further comprises one or more of:
an indication of potential ML client member(s),
an indication of whether suggested list of ML client members is required; and
a time period for analytics update for ML client members

10. The method according to claim 7, wherein the first analytics information relates to communication performance between the most recently selected group of ML servers and a plurality of potential ML client members.

11. The method according to claim 1, further comprising:
obtaining third analytics information relating to communication performance between groups of potential ML servers and a plurality of potential ML client members, wherein
the step of obtaining third analytics information comprises updating the second subscription request with a third subscription request to assist selection of ML servers, and
the third subscription request comprises an indication of a most recently selected group of ML client members; and
selecting, based on the obtained third analytics information, a second group of ML servers to perform the federated learning.

12. (canceled)

13. (canceled)

14. The method according to claim 11, wherein the third subscription request further comprises one or more of:
an indication of potential ML server(s);
an indication of whether suggested list of ML server is required; and
a time period for analytics update for ML servers.

15. The method according to claim 11, wherein the third analytics information relates to communication performance between the potential groups of ML servers and most recently selected group of ML client members.

16. The method according to claim 1, further comprising:
obtaining third analytics information relating to communication performance between groups of potential ML servers and a plurality of potential ML client members; and
selecting, based on the third analytics information, a second group of ML client members to perform the federated learning; and
selecting, based on the third analytics information, a second group of ML servers to perform the federated learning.

17. The method according to claim 1, further comprising:
receiving, from one of the potential ML servers and/or one of the potential ML client members, a request to initiate performance of federated learning, FL, wherein the request to initiate performance of FL comprises one or more of:
an indication that joint ML server and client member selection should be performed either simultaneously or alternatively;
a time intervals for ML server selections; and
a time intervals for ML client member selections.

18. (canceled)

19. A method, in a network data analytics function, NWDAF) for assisting in selection of one or more machine learning (ML) client members from a plurality of potential ML client members to perform federated learning, the method comprising:
responsive to commencement of the federated learning, receiving, from an application function, a second subscription request to assist ML client member selection;
responsive to the second subscription request, generating first analytics information relating to communication performance between potential groups of ML servers and a plurality of potential ML client members; and
transmitting the first analytics information to the application function.

20. The method according to claim 19, further comprising:
prior to commencement of the federated learning, receiving a first subscription request from the application function to assist in ML server selection, the first subscription request comprising one or more of:
an indication of the potential ML servers; and
an indication of initial ML client members.

21. The method according to claim 20, further comprising:
responsive to receiving the first subscription request, generating second analytics information relating to communication performance between potential groups of the ML servers and the initial ML client members; and
transmitting the second analytics information to the application function.

22. The method according to claim 19, wherein
the second subscription request comprises an indication of a most recently selected group of ML servers, and
the first analytics information relates to communication performance between the most recently selected group of ML servers and a plurality of potential ML client members.

23. (canceled)

24. The method according to claim 19, further comprising:
responsive to receiving a third subscription request to assist selection of ML severs, generating third analytics information relating to communication performance between groups of potential ML servers and a plurality of potential ML client members, wherein the third subscription request comprises an indication of a most recently selected group of ML client members; and
transmitting the third analytics information to the application function, wherein the third analytics information relates to communication performance between the potential groups of ML servers and most recently selected group of ML client members.

25. (canceled)

26. (canceled)

27. The method according to claim 19, further comprising:
generating third analytics information relating to communication performance between groups of potential ML servers and a plurality of potential ML client members; and
transmitting the third analytics information to the application function.

28. An application function for selection of one or more machine learning (ML) client members from a plurality of potential ML client members to perform federated learning, the application function comprising processing circuitry configured to cause the application function to:
responsive to commencement of the federated learning, obtain first analytics information relating to communication performance between potential groups of ML servers and a plurality of potential ML client members; and
select, based on the first analytics information, a first group of ML client members to perform the federated learning from the plurality of potential ML client members.

29. (canceled)

30. A network data analytics function (NWDAF) for assisting in selection of one or more machine learning (ML) client members from a plurality of potential ML client members to perform federated learning, the NWDAF comprising processing circuitry configured to cause the NWDAF to:
responsive to commencement of the federated learning, receive, from an application function, a second subscription request to assist ML client member selection;
responsive to the second subscription request, generate first analytics information relating to communication performance between potential groups of ML servers and a plurality of potential ML client members; and
transmit the first analytics information to the application function.

31-34. (canceled)
